(19) United States
(12) Patent Application Publication
(10) Pub. No.: US 2009/0150655 A1
(43) Pub. Date: Jun. 11, 2009

(54) METHOD OF UPDATING REGISTER, AND REGISTER AND COMPUTER SYSTEM TO WHICH THE METHOD CAN BE APPLIED

(76) Inventor: Moon-Gyung KIM, Suwon-si (KR)

Correspondence Address: F. CHAU & ASSOCIATES, LLC, 130 WOODBURY ROAD, WOODBURY, NY, 11797, US

(21) Appl. No.: 12/327,179

(22) Filed: Dec. 3, 2008

(30) Foreign Application Priority Data
Dec. 7, 2007 (KR) 10-2007-0126850

(51) Int. Cl. G06F 9/30

(52) U.S. Cl. 712/224; 712/E09.023

(57) ABSTRACT

A register updating method includes generating third information including first information and second information, wherein the first information indicates whether updating of regions of a register block is allowed and the second information includes information that is to be updated in the register block, transmitting the third information to an address of the register block that is to be updated, and selecting a part of the second information in a unit of the regions and writing the selected second information to the register block, based on the first information included in the received third information.

### CROSS-REFERENCE TO RELATED APPLICATIONS

This application claims priority to Korean Patent Application No. 10-2007-0126850, filed on Dec. 7, 2007, in the Korean Intellectual Property Office, the disclosure of which is incorporated by reference in its entirety herein.

### BACKGROUND

1. Technical Field

The present disclosure relates to a method and apparatus for storing information in a register, and more particularly, to a method and apparatus for partially updating information stored in a register.

2. Discussion of Related Art

A register is a device that may be included in various control devices for the temporary storage of information for a particular purpose. Information stored in a register may be updated by reading information from all fields of the register, updating the information in some of the fields that are to be updated by masking, and then storing the updated information in the register.

However, the processes of reading the register information and updating by masking may be very time consuming. Thus, there is a need for methods of updating a register in less time, registers to which the method can be applied, and systems that can implement the register and/or the method.

### SUMMARY

An exemplary embodiment of the present invention includes a register updating method. The method includes generating third information including first information and second information, wherein the first information indicates whether updating of regions of a register block is allowed and the second information includes information that is to be updated in the register block, transmitting the third information to an address of the register block that is to be updated, and selecting a part of the second information in a unit of the regions based on the first information and writing the selected second information to the register block.

The third information may be transmitted to the address of the register block that is to be updated, via a data bus. The size of the first information may be determined by the number of bits corresponding to the total number of the regions of the register block. Whether updating of the regions of the register block is allowed may be determined by values of bits of the first information.

In the second information, a value corresponding to a region of the register block that is to be updated may be set a value and values of the other regions may be randomly set. The first information may include information indicating whether updating of the register block is allowed in units of bits.

An exemplary embodiment of the present invention includes a register. The register includes a write selection unit and a storage unit. The write selection unit is configured to generate a write control signal for regions of a register block, based on first information received together with second information. The first information indicates whether updating of the regions is allowed and the second information includes information to be updated in the register block. The storage unit is configured to select a part of the second information in a unit of the regions and store the selected second information therein, according to logic values of the write control signal.

The write selection unit may include a plurality of AND gates. Each of the AND gates may be configured to generate a write control signal corresponding to one of the regions of the register block by performing an AND operation on a signal of first information corresponding to one of the regions of the register block and a write selection signal. The write selection signal may be generated by performing the AND operation on a write signal and an address signal.

The storage unit may include a flip-flop, and the write control signal corresponding to one of the regions may be supplied to a clock terminal of the flip-flop, and the selected second information may be supplied to an input terminal of the flip-flop.

An exemplary embodiment of the present invention includes a computer system. The computer system includes a register block and a central processing unit. The central processing unit is configured to generate third information comprising first information and second information, and a plurality of control signals, in response to a request for updating. The first information indicates whether updating of regions of the register block is allowed, and the second information includes information that is to be updated in the register block. The register block is configured to select a part of the second information in a unit of the regions and write the selected second information, in response to the control signals and the first information included in the third information.

The register block may include a write selection unit and a storage unit. The write selection unit may be configured to generate a write control signal to control whether to write the selected second information to the register block, in response to the control signals and the first information. The storage unit may be configured to select a part of the second information in a unit of the regions and write the selected second information to the register block, based on logic values of the write control signal.

The write selection unit may include a plurality of AND gates being respectively allocated to the regions. Each of the AND gates may be configured to generate a write control signal corresponding to one of the regions of the register block by performing an AND operation on a signal of the first information corresponding to one of the regions of the register block and a write selection signal.

The central processing unit may include an additional register (e.g., a first register). The central processing unit may store the third information in the first register, and transmit the third information stored in the first register and the control signals to an address of the register block that is to be updated, in response to a request for register updating.

### BRIEF DESCRIPTION OF THE DRAWINGS

Exemplary embodiments of the present invention will become more clearly apparent from the following detailed description taken in conjunction with the accompanying drawings in which:

FIG. 1 is a block diagram of a computer system illustrated to explain a register updating method related to the inventive concept;

FIG. 2 is a diagram illustrating exemplary data of a register illustrated in FIG. 1;

FIG. 3 is a diagram illustrating exemplary field data stored in registers illustrated in FIG. 1 according to an update process illustrated in FIG. 1;

FIG. 4 is a block diagram of a computer system according to an exemplary embodiment of the present invention;

FIG. 5 is a diagram illustrating an example of third information generated according to an exemplary embodiment of the present invention;

FIG. 6 is a block diagram illustrating an exemplary embodiment of a register block illustrated in FIG. 4;

FIG. 7 illustrates an exemplary embodiment of a register set illustrated in FIG. 6;

FIG. 8 illustrates a register updating unit according to an exemplary embodiment of the present invention;

FIG. 9 is a block diagram of a register according to an exemplary embodiment of the present invention;

FIG. 10 is a flowchart illustrating a register updating method according to an exemplary embodiment of the present invention;

FIG. 11A is a diagram illustrating exemplary field data stored in each of a plurality of regions of a register block before updating;

FIG. 11B illustrates an example of third information generated and stored in a register in response to a request for updating; and

FIG. 11C illustrates exemplary field data stored in each of the regions of the register block illustrated in FIG. 11A after the updating.

### DETAILED DESCRIPTION OF EXEMPLARY EMBODIMENTS

Hereinafter, exemplary embodiments of the present invention will be described in detail with reference to the accompanying drawings. However, the invention may be embodied in many different forms and should not be construed as being limited to the embodiments set forth herein.

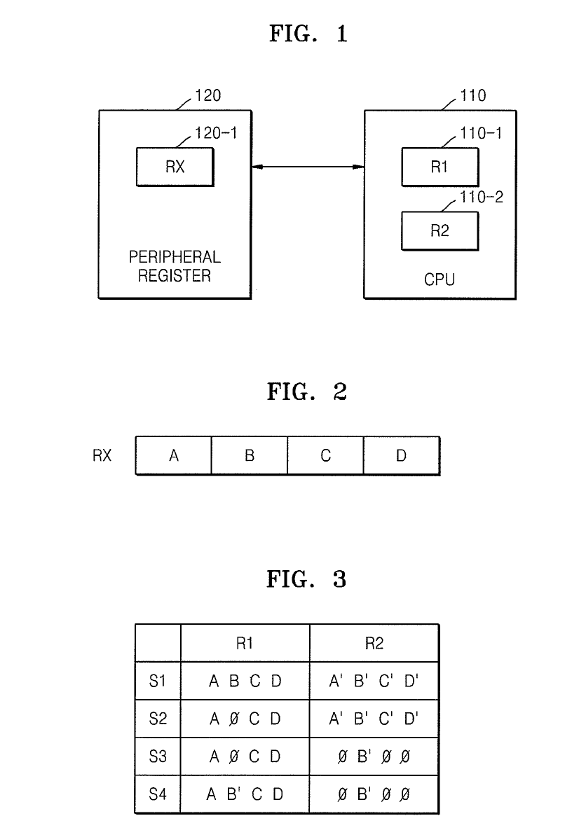

As illustrated in FIG. 1, a computer system may include a central processing unit (CPU) 110 and a peripheral register 120. The CPU 110 includes registers R1 110-1 and R2 110-2 and the peripheral register 120 includes register RX 120-1. The register RX 120-1 may be divided into a plurality of regions based on the intended use of the register. A conventional method of partially updating values stored in the register RX 120-1 will be described using the example that follows. In this example, it is assumed that the register RX 120-1 is divided into four regions and field data A, B, C, and D are stored in the four regions, as illustrated in FIG. 2. The following process is performed when the second field data is to be updated to B′.

The CPU 110 reads the value of the register RX 120-1, loads the read value in a register R1 110-1 included in the CPU 110, and loads data that is to be updated in a register R2 110-2 (operation S1). Thus, as illustrated in FIG. 3, in operation S1, the field data A, B, C, and D are stored in the register R1 110-1, and field data A′, B′, C′, and D′ are stored in the register R2 110-2. The field data A′, C′, and D′ stored in the first, third and fourth fields of the register R2 110-2 are used without being changed, and the field data B′ in the second field of the register R2 110-2 is determined to be updated. The field data B stored in a region of the register R1 110-1, which is to be updated, is masked to be ‘0’ (operation S2). The field data A′, C′, and D′ stored in all the regions of the register R2 110-2 except for a region that is to be updated, are masked to be 0′ (operation S3). An OR operation is performed on the field data stored in the register R1 110-1 and the field data stored in the register R2 110-2, and the result of the operation is stored in the register R1 110-1 (operation S4). As a result, the field data A, B′, C, and D are stored in the register R1 110-1 as illustrated in FIG. 3. The value of the register RX 120-1 are updated to be the field data A, B′, C, and D by the value of the stored register R1 110-1.

A register updating method according to an exemplary embodiment of the present invention differs from the above described method in that it may skip the process of reading values of a peripheral register and processing the read values by masking. A partial updating is performed on each of the regions of a register block by generating third information UD_DATA including first information (update information (UI)) indicating whether a CPU authorizes updating of each of the regions of the register block and second information R_DATA that is to be updated in the register block, and then transmitting the third information UD_DATA to the register block, in response to a request for register updating.

The register block may be an array of unit registers each storing 1-bit data. For example, a 16-bit register block may include sixteen unit registers. The register block can be divided into a plurality of regions. For example, a 16-bit register block may be divided into four regions each being allocated 4 bits.

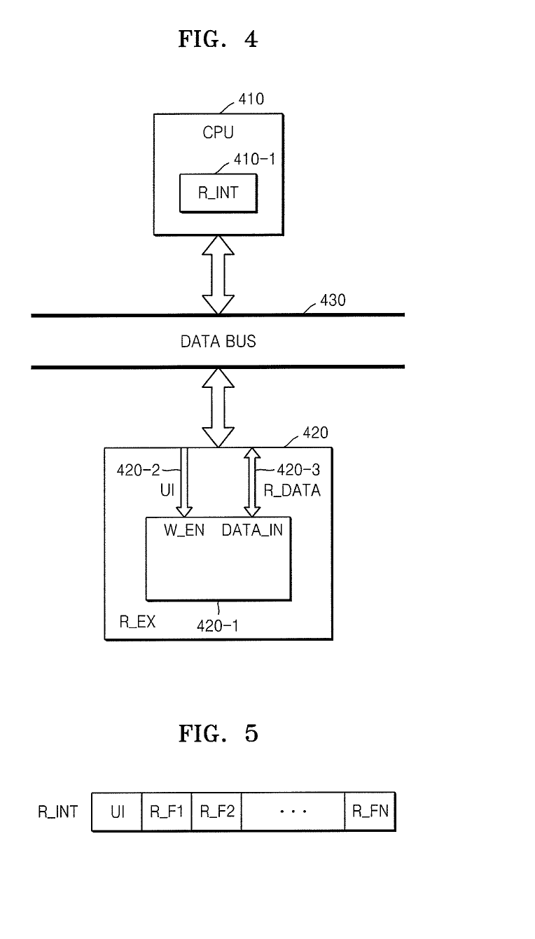

The proposed register updating method will now be described in greater detail with reference to a computer system illustrated in FIG. 4. Referring to FIG. 4, the computer system includes a CPU 410, a register block R_EX 420, and a data bus 430. The CPU 410 includes a register R_INT 410-1 for register updating. The CPU 410 may include additional registers (not shown) to performing arithmetic and data processing.

The CPU 410 may control an overall operation of the computer system, e.g., execution of commands, write operations, read operations, etc., and may further perform a control for register updating according to an exemplary embodiment of the present invention.

The CPU 410 generates third information UD_DATA including first information UI indicating whether updating of each region of the register block R_EX 420 is authorized and second information R_DATA that is to be updated in the register block R_EX 420, and stores the third information UD_DATA in the register R_INT 410-1, in response to a request for register updating.

FIG. 5 illustrates an example of a data organized in the third information UD_DATA. Referring to FIG. 5, the third information UD_DATA may include a combination of first information UI, and field data R_F1, R_F2, through to R_FN that are second information R_DATA to be updated in the register block R_EX 420 that is divided into N regions (N is an integer which may be equal to or greater than 2).

The size of the first information UI may be determined by the number of bits corresponding to the total number of the N regions of the register block R_EX 420 that is to be updated. Whether updating of the regions of the register block R_EX 420 that are to be updated is authorized may be determined by the logic value of bits of the first information UI.

In the second information R_DATA, only a value corresponding to a region of the register block R_EX 420 that is to be partially updated is set to a value that is to be actually updated and values of the other regions of the register block R_EX 420 may be randomly set.

For example, as illustrated in FIG. 11A, it is assumed that the register block R_EX 420 is divided into four regions and the regions respectively store field data A, B, C, and D. In order to partially update the field data B (e.g., update field data B without effecting field data A, C, and D) stored in the second region of the register block R_EX 420 to ‘B”, the CPU 410 generates the third information UD_DATA as illustrated in FIG. 11B and stores it in the register R_INT 410-1.

Referring to FIG. 11B, the first information UI is set to a value of ‘0100’. When the first information UI is designed in such a manner that the logic value of ‘1’ indicates that updating is authorized and the logic value of ‘0’ indicates that updating is not authorized, the value of ‘0100’ means that updating of only the field data B in the second region is authorized and updating of the field data stored in the other regions is not authorized. In the second information R_DATA, the field data stored in the second region, which corresponds to a region of the register block R_EX 420 that is to be partially updated, is set to B′ that is to be updated information, and the field data stored in the other regions may be set to random values. Thus, referring to FIG. 11B, field data A′, and C′, and D′ stored in the first, third and fourth regions of the second information R_DATA are not to be updated and may have random values.

The CPU 410 stores the third information UD_DATA in the register R_INT 410, and then transmits the stored third information UD_DATA to the register block R_EX 420 via the data bus 430. The CPU 410 may generate a plurality of control signals needed for updating. The control signals may include a write signal and an address signal.

The register block R_EX 420 includes a register set 420-1 including the respective regions, and first and second signal connecting lines 420-2 and 420-3. The first signal connecting line 420-2 may be a data bus transmitting the first information UI included in the third information UD_DATA, and the second signal connecting line 420-3 may be a data bus transmitting the second information R_DATA included in the third information UD_DATA. The first signal connecting line 420-2 is connected to a write enable terminal W_EN of the register set 420-1. The second signal connecting line 420-3 is connected to a data input terminal DATA_IN of the register set 420-1.

Data can be written to the register set 420-1 when the write enable terminal W_EN is set to an activation logic value, and data cannot be written to the register set when the write enable terminal W_EN is not set to the activation logic value. Thus, whether data is to be written to a register set of the register block R_EX 420 may be determined by the logic values of the first information UI input to the write enable terminal W_EN of the register set.

For example, the register block R_EX 420 can be used as a system function register. When the frequencies of a plurality of clock signals are individually determined by values stored in the regions of the register block R_EX 420, the register block R_EX 420 can be partially updated using the above described method.

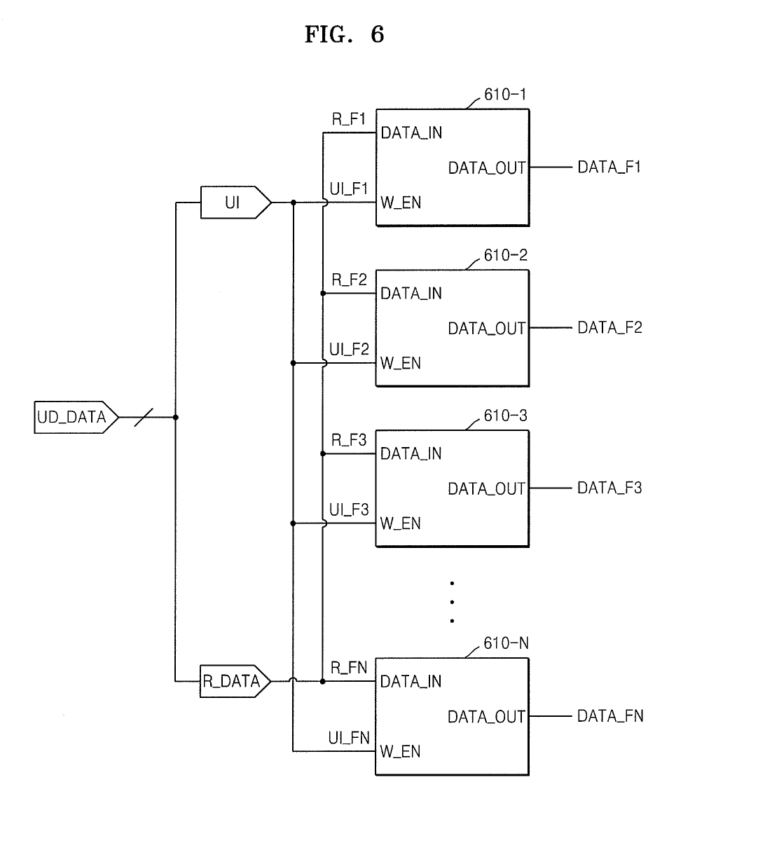

FIG. 6 is a block diagram illustrating an embodiment of the register block R_EX 420 illustrated in FIG. 4. FIG. 6 illustrates that the register block R_EX 420 includes register sets for respective N regions. In this example, the register block R_EX 420 includes a first register set 610-1 storing field data DATA_F1 of the first region, a second register set 610-2 storing field data DATA_F2 of the second region, a third register set 610-3 storing field data DATA_F3 of the third region, through to an N^{th} register set 610-N storing field data DATA_FN of the N^{th} region.

Information UI_F1 for determining whether the first region of the register block R_EX 420 is to be updated is supplied to a write enable terminal W_EN of the first register set 610-1, from among a plurality of parts of information included in the first information UI. The field data R_F1 of the first region, which is included in the second information R_DATA, is supplied to a data input terminal DATA_IN of the first register set 610-1. The field data DATA_F1 stored in the first region is output via a data output terminal DATA_OUT of the first register set 610-1.

Information UI_F2 for determining whether the second region of the register block R_EX 420 is to be updated is supplied to a write enable terminal W_EN of the second register set 610-2, from among the parts of information included in the first information UI. The field data R_F2 of the second region, which is included in the second information R_DATA, is supplied to a data input terminal DATA_IN of the second register set 610-2. The field data DATA_F2 stored in the second region is output via a data output terminal DATA_OUT of the second register set 610-2.

Information UI_F3 for determining whether the third region of the register block R_EX 420 is to be updated is supplied to a write enable terminal W_EN of the third register set 610-3, from among the parts of information included in the first information UI. The field data R_F3 of the third region, which is included in the second information R_DATA, is supplied to a data input terminal DATA_IN of the third register set 610-3. The field data DATA_F3 stored in the third region is output via a data output terminal DATA_OUT of the third register set 610-3.

Information UI_FN for determining whether the N^{th} region of the register block R_EX 420 is to be updated is supplied to a write enable terminal W_EN of the N^{th} register set 610-N, from among the parts of information included in the first information UI. The field data R_FN of the N^{th} region, which is included in the second information R_DATA, is supplied to a data input terminal DATA_IN of the N^{th} register set 610-N. The field data DATA_FN stored in the N^{th} region is output via a data output terminal DATA_OUT of the N^{th} register set 610-N.

For example, when it is assumed that N=4 and the third information UD_DATA is as illustrated in FIG. 11B, the information UI_F1, UI_F3, and UI_F4 illustrated in FIG. 6 has a logic value of 0, the other information UI_F2 has a logic value of 1, and the field data R_F1, R_F2, R_F3, and R_F4 are respectively A′, B′, C′, and D′. Accordingly, data input via the data input terminal DATA_IN is allowed to be written to only the second register set 610-2 in which the logic value of 1 is supplied to the write enable terminal W_EN, and is not allowed to be written to the other register sets. As a result, only the field data in the second region of the register block R_EX 420 can be partially updated.

For example, it is assumed that before register updating, the field data A, B, C, and D illustrated in FIG. 11A are stored in the first through fourth register sets 610-1 through 610-4 and the third information UD_DATA illustrated in FIG. 11B is transmitted to the register block R_EX 420. In this example, referring to FIG. 6, according to the first information UI, only data writing to the second register set 610-2 is allowed, and thus, the field data in the register block R_EX 420 becomes A, B′, C, and D after updating, as illustrated in FIG. 11C.

When the field data in each of the regions of the register block R_EX 420 is 4-bit data, each of the first through Nth register sets 610-1 through 610-N illustrated in FIG. 6 includes four registers, each of which can store 1-bit data.

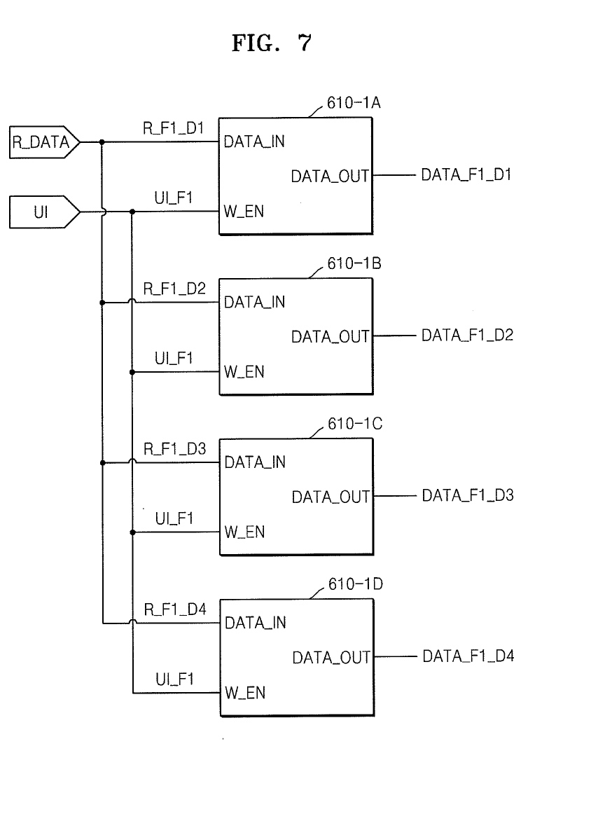

FIG. 7 illustrates an exemplary embodiment of the first register set 610-1 configured to store the field data DATA_F1 of the first region when the field data in each of the regions of the register block R_EX 420 is 4-bit data. The other register sets (e.g., 610-2-610-N) may be configured to store 4-bit data in a similar manner.

Referring to FIG. 7, information UI_F1 for determining whether the first region is to be updated may be commonly supplied to a write enable terminal W_EN of each of a plurality of registers 610-1A, 610-1B, 610-1C, and 610-1D of the first register set 610-1, from among the parts of the information included in the first information UI. Data R_F1_D1, R_F1_D2, R_F1_D3, and R_F1_D4 of the field data R_F1 of the first region, which is included in the second information R_DATA, may be respectively supplied to data input terminals DATA_IN of the registers 610-1A, 610-1B, 610-1C, and 610-1D. Register data DATA_F1_D1, DATA_F1_D2, DATA_F1_D3, and DATA_F1_D4 included in the first region may be respectively output via data output terminals DATA_OUT of the registers 610-1A, 610-1B, 610-1C, and 610-1D.

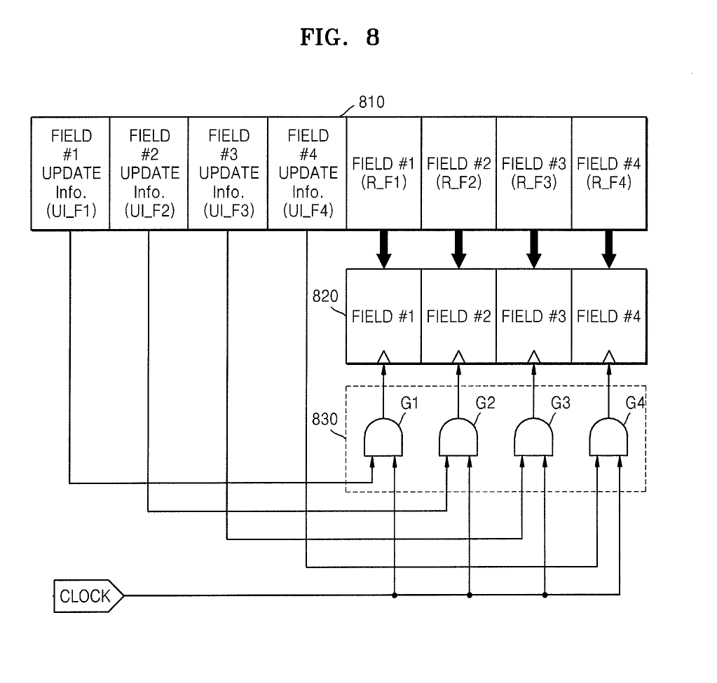

FIG. 8 illustrates a register updating unit according to an exemplary embodiment of the present invention. Referring to FIGS. 4 and 8, reference numeral ‘810’ denotes the third information UD_DATA stored in the register R_INT 410-1 of the CPU 410, reference numeral ‘820’ denotes first, second, third, and fourth register sets storing field data of the respective regions of the register block R_EX 420, and reference numeral ‘830’ denotes a write selection circuit consisting of first, second, third and fourth AND gates G1, G2, G3, and G4.

Referring to FIG. 8, the third information UD_DATA comprises first information UI (update information) including update information UI_F1, UI_F2, UI_F3, and UI_F4 corresponding to fields #1, 2, 3, and 4 of the regions, and second information including update data R_F1, R_F2, R_F3, and R_F4 corresponding to the fields #1, 2, 3, and 4.

The update information UI_F1, UI_F2, UI_F3, and UI_F4 corresponding to the fields #1, 2, 3, and 4 may be respectively supplied to first input terminals of first, second, third and fourth AND gates G1, G2, G3, and G4 of the write selection circuit 830. The update data R_F1, R_F2, R_F3, and R_F4 of the fields #1, 2, 3, and 4 may be respectively supplied to input terminals of the first, second, third, and fourth register sets 820. Output terminals of the first, second, third and fourth AND gates G1, G2, G3, and G4 may be respectively connected to clock input terminals of the first, second, third, and fourth register sets 820. When a clock signal is input to the clock input terminal of the first, second, third, and fourth register sets 820, data supplied to the input terminals of the register sets may be written to the register sets.

The write selection circuit 830 may perform a gating operation on a clock signal needed for updating based on the first information UI, and may further supply the gating result to the register sets 820.

When the update information UI_F1, UI_F2, UI_F3, and UI_F4 of the fields #1, 2, 3, and 4 are ‘0100’ as illustrated in FIG. 11B, the logic states of the first input terminals of the first, third, and fourth AND gates G1, G3, and G4 are ‘0’ and the first, third, and fourth AND gates G1, G3, and G4 output a value of ‘0’, thereby preventing the clock signal from being supplied to the first, third and fourth register sets. The logic state of the first input terminal of the second AND gate G2 is ‘1’, thus allowing the clock signal supplied to a second input terminal of the second AND gate G2 to be supplied to the second register set. Thus, only the update data R_F2 of the field #2 supplied to the input terminal of the second register set is written to the register block R_EX 420, and the update data R_F1, R_F3, and R_F4 of the fields #1, 3 and 4 supplied to the input terminals of the other first, second, and third register sets are not written.

Accordingly, the data in the register block R_EX 420 can be selectively and partially updated on a field basis according to the update information UI_F1, UI_F2, UI_F3, and UI_F4 corresponding to the fields #1, 2, 3, and 4.

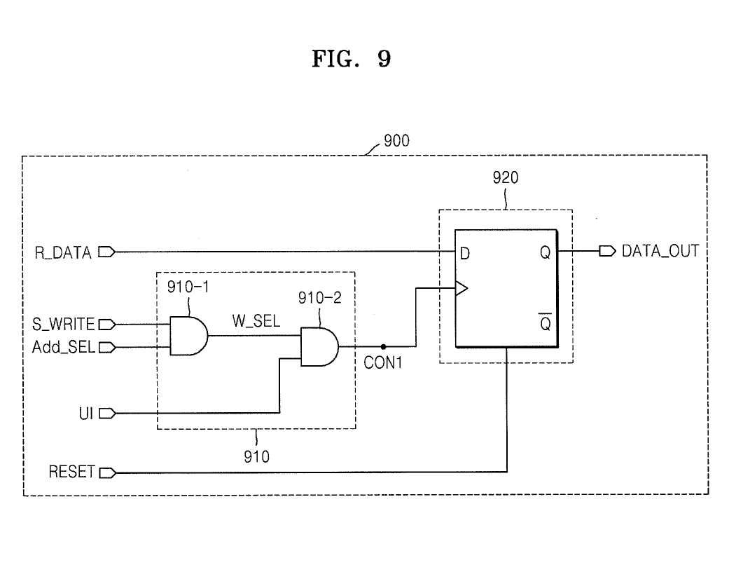

FIG. 9 is a block diagram illustrating a 1-bit unit register including a register block according to an exemplary embodiment of the present invention. Referring to FIG. 9, the register 900 includes a write selection unit 910 and a storage unit 920.

The write selection unit 910 receives a write signal S_WRITE, an address signal Add_SEL and a signal of first information UI corresponding to a target region of the register block, and may output a write control signal CON1 in response to these signals.

The storage unit 920 stores data of second information R_DATA for updating bits received via a data input terminal thereof, in response to the write control signal CON1. The storage unit 920 may be reset in an initial stage in response to the reception of a reset signal RESET set to an activation level. The initial stage may comprise supplying the reset signal RESET only once to the storage unit 920.

The write signal S_WRITE is a signal requesting the data of the second information R_DATA received via the data input terminal to be stored in the storage unit 920. The address signal Add_SEL may be generated to select the storage unit 920. For example, transmission of the address signal Add_SEL set to the activation level may indicate that the storage unit 920 is selected.

The first information signal UI indicates a logic value of information for determining whether the target region is to be updated. The signal of the first information UI may also contain information indicating whether data stored in the storage unit 920 is to be maintained or whether new data that is to be transmitted is to be written to the storage unit 920. When the signal of the first information UI set to the activation level is output, new data of the second information R_DATA corresponding to the received bits may be written and stored in the storage unit 920, in response to the signal of the first information UI.

The write control signal CON1 may be transmitted to the storage unit 920 to control a write operation of the storage unit 920. When the signal of the first information UI, the write signal S_WRITE, and the address signal Add_SEL are received and set to the activation level, the write control signal CON1 controls the storage unit 920 to store the data of the second information R_DATA for updating the received bits. The signal of the first information UI corresponds to the target region.

The write selection unit 910 includes first and second AND gates 910-1 and 910-2. The first AND gate 910-1 receives the write signal S_WRITE and the address signal Add_SEL, performs an AND operation on these signals, and then outputs the write selection signal W_SEL. The second AND gate 910-2 receives the write selection signal W_SEL and the signal of the first information UI, performs an AND operation on these signals, and then outputs the write control signal CON1.

While the storage unit 920 is embodied as a flip-flop in FIG. 9, various storage devices may be used. The storage unit 920 receives the write control signal CON1 via a clock input terminal thereof, and the data of the second information R_DATA via a data input terminal thereof. The storage unit 920 may be configured to only output the data of the second information R_DATA via an output terminal Q thereof when the supplied write control signal CON is set to the activation level. The data of the second information R_DATA may be output in synchronization with the write control signal CON1.

As described above, when a write signal is received, the signal of the first information UI may be received together with the data of the second information R_DATA and then the second information R_DATA may be written to a register block only when the signal of the first information UI is at the activation level. Thus, the second information R_DATA can be partially written to the register block in units of the regions of the register block according to the first information UI.

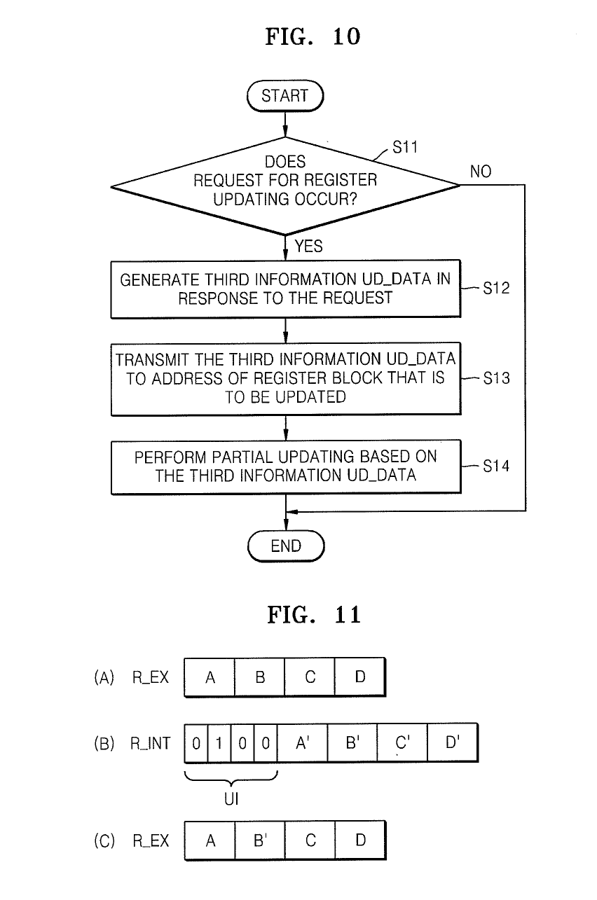

A register updating method according to an exemplary embodiment of the present invention will be explained with reference to the flowchart of FIG. 10 and the computer system illustrated in FIG. 4.

The CPU 410 determines whether a request for register updating occurs (S11). The request for register updating occurs when values stored in all or some of the regions of the register block R_EX 420 need to be updated with new values. For example, when frequencies of a plurality of clock signals are individually determined by the values stored in the regions of the register block R_EX 420, the request for register updating occurs in order to change the frequency of one of the clock signals.

When it is determined in operation S11 that the request for register updating has occurred, the CPU 410 generates third information UD_DATA including the first information UI that indicates whether updating of each of the regions of the register bock R_EX 420 is allowed and the second information R_DATA that is to be updated in the register block R_EX 420, in response to the request for register updating (operation S12).

The size of the first information UI may be determined by the number of bits corresponding to the total number of the regions of the register block R_EX 420 that are to be updated. Whether updating of the regions of the register block R_EX 420 that is to be updated is allowed, may be determined by logic values of bits of the first information UI.

In the second information R_DATA, only a value corresponding to a region of the register block R_EX 420 that is to be partially updated is set to a value and values of the other regions of the register block R_EX 420 may be randomly set. The CPU 410 transmits the third information UD_DATA to the address of the register block R_EX 420 that is to be updated via the data bus (operation S13).

In the register block R_EX 420 receiving the third information UD_DATA, partial updating is performed by selecting data from the second information R_DATA in units of the regions of the register block R_EX 420 according to the first information UI included in the third information UD_DATA (operation S14). For example, the register block R_EX 420 can be partially updated by writing only data from the second information R_DATA to the region of the register block R_EX 420, where updating is allowed, based on the first information UI.

In at least one embodiment of the present invention, whether updating of each of the regions of a register block is allowed is determined based on the first information UI. However, if the regions of the register block are extended on a bit-by-bit basis, whether updating of the register block is allowed may be determined in units of bits, based on the first information UI. For example, when the first information UI is designed to indicate whether updating of the register block is allowed in units of bits, the register block can be partially updated by using the first information UI.

While the present invention have been particularly shown and described with reference to exemplary embodiments thereof, it will be understood by those of ordinary skill in the art that various changes in form and details may be made therein without departing from the spirit and scope of the disclosure.

What is claimed is:

1. A register updating method comprising:
generating third information including first information and second information, wherein the first information indicates whether updating of regions of a register block is allowed and the second information includes information that is to be updated in the register block;
transmitting the third information to an address of the register block that is to be updated; and
selecting a part of the second information in a unit of the regions based on the first information and writing the selected second information to the register block.

2. The method of claim 1, wherein the third information is transmitted to the address of the register block that is to be updated, via a data bus.

3. The method of claim 1, wherein the size of the first information is determined by the number of bits corresponding to the total number of the regions of the register block.

4. The method of claim 1, wherein whether updating of the regions of the register block is allowed is determined by values of bits of the first information.

5. The method of claim 1, wherein in the second information, a value corresponding to a region of the register block that is to be updated is set to be a value and values of the other regions are randomly set.

6. The method of claim 1, wherein the first information comprises information indicating whether updating of the register block is allowed in units of bits.

7. A register comprising:
a write selection unit configured to generate a write control signal for regions of a register block, based on first information received together with second information, wherein the first information indicates whether updating of the regions is allowed and the second information includes information to be updated in the register block; and
a storage unit configured to select a part of the second information in a unit of the regions and store the selected second information therein, according to a logic value of the write control signal.

8. The register of claim 7, wherein the size of the first information is determined by the number of bits corresponding to the total number of the regions of the register block.

9. The register of claim 7, wherein whether updating of the regions of the register block is determined by values of bits of the first information.

10. The register of claim 7, wherein in the second information, only a value corresponding to a region of the register block that is to be updated is set to a value and values of the other regions are randomly set.

11. The register of claim 7, wherein the write selection unit comprises a plurality of AND gates, each of the AND gates is configured to generate a write control signal corresponding to one of the regions of the register block by performing an AND operation on a signal of the first information corresponding to one of the regions of the register block and a write selection signal.

12. The register of claim 11, wherein the write selection signal is generated by performing an AND operation on a write signal and an address signal.

13. The register of claim 7, wherein the storage unit comprises a flip-flop, and the write control signal corresponding to one of the regions is supplied to a clock terminal of the flip-flop, and the selected second information is supplied to an input terminal of the flip-flop.

14. A computer system comprising:
a register block; and
a central processing unit configured to generate third information comprising first information and second information, and a plurality of control signals, in response to a request for updating, wherein the first information indicates whether updating of regions of the register block is allowed, and the second information includes information that is to be updated in the register block, and
wherein the register block is configured to select a part of the second information in a unit of the regions and write the selected second information, in response to the control signals and the first information included in the third information.

15. The computer system of claim 14, wherein the control signals comprise a write signal and an address signal.

16. The computer system of claim 14, further comprising a data bus, wherein the third information is delivered from the central processing unit to the register block via the data bus.

17. The computer system of claim 14, wherein the register block comprises:
a write selection unit generating a write control signal configured to control whether to write the selected second information to the register block, in response to the control signals and the first information; and
a storage unit configured to select a part of the second information in a unit of the regions and write the selected second information to the register block, based on logic value of the write control signal.

18. The computer system of claim 17, wherein the write selection unit comprises a plurality of AND gates being respectively allocated to the regions, each of the AND gates generating a write control signal corresponding to one of the regions of the register block by performing an AND operation on a signal of the first information corresponding to one of the regions of the register block and a write selection signal.

19. The computer system of claim 18, wherein the write selection signal is generated by performing the AND operation on a write signal and an address signal.

20. The computer system of claim 14, wherein a first register is included in the central processing unit, and
the central processing unit stores the third information in the first register, and transmits the third information stored in the first register and the control signals to an address of the register block that is to be updated, in response to a request for register updating.
